(19) United States
(12) Patent Application Publication
(10) Pub. No.: US 2016/0008767 A1
(43) Pub. Date: Jan. 14, 2016

(54) METHOD OF PRODUCING COMPOSITE FOR ACID GAS SEPARATION

(71) Applicant: FUJIFILM Corporation, Tokyo (JP)

(72) Inventor: Satoshi YONEYAMA, Ashigarakami-gun (JP)

(73) Assignee: FUJIFILM CORPORATION, Tokyo (JP)

(21) Appl. No.: 14/860,890

(22) Filed: Sep. 22, 2015

Related U.S. Application Data
(63) Continuation of application No. PCT/JP2014/001767, filed on Mar. 27, 2014.

(30) Foreign Application Priority Data
Mar. 29, 2013 (JP) 2013-072016

(51) Int. Cl. B01D 69/12; B01D 69/14; B01D 71/38; B01D 53/22; B01D 69/10; B01D 67/00

(52) U.S. Cl. CPC B01D 69/12; B01D 69/10; B01D 67/0002; B01D 71/38; B01D 53/228; B01D 69/142; B01D 2257/304; B01D 2257/504; B01D 2256/16; B01D 2256/20; B01D 2325/04; B01D 2325/38; B01D 2323/02

(57) ABSTRACT

An art is provided for preparing a coating liquid for formation of an acid gas separation facilitated transport membrane, the coating liquid containing a hydrophilic compound, an acid gas carrier and water, using as a porous support a laminated membrane between a hydrophobic porous membrane and an auxiliary support membrane, coating onto a surface of the hydrophobic porous membrane of the laminated membrane the coating liquid for formation at a liquid membrane thickness of 0.3 mm or more and 1.0 mm or less, and drying the coated liquid membrane to form a first acid gas separation facilitated transport membrane, and further coating the coating liquid for formation of the acid gas separation facilitated transport membrane onto the previously formed acid gas separation facilitated transport membrane, and drying the coated liquid membrane to form a next acid gas separation facilitated transport membrane.

### CROSS REFERENCE TO RELATED APPLICATIONS

The present application is a Constitution of PCT International Application No. PCT/JP2014/001767 filed on Mar. 27, 2014, which claims priority under 35 U.S.C. §119(a) to Japanese Patent Application No. 2013-072016 filed on Mar. 29, 2013. Each of the above applications is hereby expressly incorporated by reference in its entirety, into the present application.

### BACKGROUND

The present disclosure relates to a method of producing a composite for acid gas separation, the composite having a function of separating an acid gas.

In recent years, development has advanced in techniques for selectively separating an acid gas in a mixed gas. In particular, the development has advanced in a technique for selectively separating carbon dioxide. As global warming countermeasures, for example, a technique has been developed in which carbon dioxide in an exhaust gas is recovered and concentrated, or hydrocarbon is reformed into hydrogen and carbon monoxide (CO) by steam reforming, and further allowing carbon monoxide to react with steam to produce carbon dioxide and hydrogen, and carbon dioxide is eliminated by a membrane through which carbon dioxide is selectively transmitted to obtain a gas containing as a main component hydrogen and for fuel cells or the like.

As an acid gas separation membrane through which such an acid gas is selectively transmitted and separated, a facilitated transport membrane is known in which the acid gas is conveyed from a side of the membrane for feeding an original gas to an opposite side to separate the acid gas.

For example, Japanese Examined Patent Publication No. 7(1995)-102310 (hereinafter, Patent Document 1) describes a method of producing a composite for carbon dioxide separation, in which an aqueous solution of uncrosslinked vinyl alcohol-acrylate copolymer is coated onto a carbon dioxide-permeable support in a membrane shape to form a liquid membrane of the aqueous solution of uncrosslinked vinyl alcohol-acrylate copolymer on the support, and then the liquid membrane is heated to cause crosslinking to form a water-insolubilized membrane, and an aqueous solution containing a carbon dioxide carrier (substance having affinity with carbon dioxide) is absorbed into the water-insolubilized membrane to produce a hydrogel membrane, and the facilitated transport membrane composed of the hydrogel membrane is supported onto the support

Japanese Unexamined Patent Publication No. 2012-143711 (hereinafter, Patent Document 2) describes a method of producing a composite for carbon dioxide separation, in which a gelling agent such as agar is added to a coating liquid containing a polyvinyl alcohol-polyacrylic acid copolymer and alkali metal carbonate, the coating liquid prepared at 50° C. or higher is coated onto a support, and then the resultant liquid membrane is cooled to cause gelation, and then causing drying to support a facilitated transport membrane onto the support.

### SUMMARY

In Patent Document 1, a gel membrane thickness of about 1 to 200 μm is assumed, and in Patent Document 2, formation of a facilitated transport membrane having a thickness of about 5 to 50 μm is assumed by coating a coating liquid at a liquid membrane thickness of 1 mm or less to cause gelation and drying.

Incidentally, when carbon dioxide is separated from a mixed gas of carbon dioxide and hydrogen, for example, although the facilitated transport membrane for carbon dioxide separation positively permeates carbon dioxide by a chemical reaction, hydrogen is dissolved into a membrane surface and diffused and permeated thereinto. Therefore, from a viewpoint of reducing hydrogen permeability, accordingly as the thickness of the facilitated transport membrane is larger, the membrane is better. Moreover, in the case of a production method in which such a gel membrane as mentioned above is formed on the support by coating/drying, if the membrane thickness is small, the membrane becomes sensitive to foreign matters on a surface of the support or air bubbles mixed into the gel membrane, and defects such as pinholes are liable to occur in the gel membrane.

From these circumstances, a request has been expressed for a facilitated transport membrane having a larger thickness in comparison with the cases in Patent Documents 1 and 2. It can also be considered that the liquid membrane may be simply coated thicker during coating the liquid membrane onto the support. Meanwhile, studies by the present inventors have revealed that, when the liquid membrane so thick as exceeding 3 mm in a thickness of an applied liquid before drying is coated and dried, drying processes between a membrane surface side and a support side are significantly different, and the liquid on the membrane surface side is rapidly dried to form a coat, and therefore scale-shaped unevenness on the membrane surface is caused or localization of carriers or polymers occurs. Moreover, in order to dry a thick liquid membrane, such drying needs a coater with a design of a significantly long drying oven also in a production process and also has a problem of needing introduction of new facilities.

The present disclosure has been made in view of the above-described problems, and provides a method of producing a composite for acid gas separation, the composite provided with a thick acid gas separation facilitated transport membrane.

A method of producing a composite for acid gas separation of the present disclosure refers to the method of producing the composite for acid gas separation, the composite provided with an acid gas separation facilitated transport membrane having a function of separating an acid gas in a raw material gas on a porous support, including:

a coating liquid preparation step for preparing a coating liquid for formation of the acid gas separation facilitated transport membrane, the coating liquid containing a hydrophilic compound, an acid gas carrier and water;

an initial layer formation step for forming a first acid gas separation facilitated transport membrane by using as the porous support a laminated membrane between a hydrophobic porous membrane and an auxiliary support membrane, coating on a surface of the hydrophobic porous membrane of the laminated membrane the coating liquid for formation at a liquid membrane thickness of 0.3 mm or more and 1.0 mm or less, and drying the coated liquid membrane; and

a next layer formation step one or more times for forming a next acid gas separation facilitated transport membrane by further coating on the previously formed acid gas separation facilitated transport membrane the coating liquid for formation of the acid gas separation facilitated transport membrane, and drying the coated liquid membrane.

The coating liquid for formation of the acid gas separation facilitated transport membrane preferably has a measured value of viscosity of 0.5 Pa·s or more and 5 Pa·s or less at a temperature of 15° C. or higher and 35 ° C. or lower, and at 60 rpm in the number of revolutions in B type viscosity measurement.

In the next layer formation step, the coating liquid for formation of the acid gas separation facilitated transport membrane is preferably coated at the liquid membrane thickness of 3.0 mm or less.

As a coating method, a roll coating method or a blade coating method is preferred.

The hydrophilic compound is preferably a polyvinyl alcohol-polyacrylic acid copolymer.

The acid gas carrier preferably contains a compound containing at least one selected from alkali metal carbonate.

In the method of producing the composite for acid gas separation of the disclosure, in the coating liquid preparation step, a plurality of coating liquids for formation in which concentrations of the acid gas carriers are different may be prepared as the coating liquid for formation of the acid gas separation facilitated transport membrane, and

in the next layer formation step, a next layer acid gas separation facilitated transport membrane may be formed by using coating liquids for formation in which the concentrations of the acid gas carriers are different from the coating liquid for formation upon forming the previously formed acid gas separation facilitated transport membrane. From viewpoints of membrane strength and salting out of the applied liquid, the coating liquid for formation in which the concentration of the acid gas carrier is low is further preferably used.

Further, in the coating liquid preparation step, as the coating liquid for formation of the acid gas separation facilitated transport membrane, a plurality of coating liquids for formation in which the hydrophilic compounds are different are prepared, and in the next layer formation step, such an acid gas separation facilitated transport membrane may be formed in which a hydrophilic compound is different from the compound in the previously formed coating liquid for formation upon forming the acid gas separation facilitated transport membrane.

Here, “hydrophilic compounds are different” means a case where constituents per se are different with each other, and also a case where, even in a copolymer formed of identical kinds of monomers, the copolymer has a different copolymerization ratio. For example, when the hydrophilic compound in the coating liquid for formation of the first acid gas separation facilitated transport membrane is a polyvinyl alcohol-polyacrylic acid copolymer, the latter case includes use of a hydrophilic compound containing a polyvinyl alcohol-polyacrylic acid copolymer having a different copolymerization ratio as the coating liquid for formation of the acid gas separation facilitated transport membrane for the next layer.

In addition, in the step for preparing the coating liquid for formation of the acid gas separation facilitated transport membrane, a coating liquid for formation may be further prepared, in which an amount of addition of a thickener, an additive or the like is different, and different coating liquids for formation may be used during forming the first acid gas separation facilitated transport membrane and during forming the next acid gas separation facilitated transport membrane. Furthermore, coating liquids for formation may be prepared, in which a plurality of a concentration of the gas carrier concentration, a concentration of the hydrophilic compound and a concentration of the amount of addition of the thickener, the additive or the like are different, and different coating liquids for formation may be used during forming the first acid gas separation facilitated transport membrane and during forming the next acid gas separation facilitated transport membrane.

When the coating liquids are coated to form three or more layers of the acid gas separation facilitated transport membranes, a first layer and a second layer may be formed by using an identical coating liquid for formation and a third layer may be formed by using a different coating liquid for formation.

According to a method of producing a composite for acid gas separation of the present disclosure, an acid gas separation facilitated transport membrane is formed on a support in an initial layer formation step, and a next layer formation step one or more times, and coating of a liquid membrane and drying is repeated a plurality of times to form the acid gas separation facilitated transport membrane. Therefore, a thick and membrane defect-free composite membrane for acid gas separation can be obtained. In the initial layer formation step, a liquid membrane thickness of 0.3 mm or more is achieved. Thus, even in the case of a hydrophobic porous membrane, the liquid membrane can be coated in the form of a continuous membrane. A coated surface becomes hydrophilic due to formation of the initial layer. Therefore, a liquid membrane thickness on and after a next layer can be decreased without paying attention to water repellency, and affinity is satisfactory, and therefore the thickness can be sufficiently increased, in which a degree of freedom of a thickness design is high.

Moreover, coating and drying are performed a plurality of times. Therefore, even if a defect occurs in the initial layer due to foreign matters on the support surface during forming the initial layer or poor transfer during coating, a defect portion can be buried in the next layer formation step, and therefore a facilitated transport membrane having a smaller number of defects can be obtained.

Further, when the composite for acid gas separation is produced according to a roll-to-roll process, if formation of a thick membrane is attempted in a coating and drying step only once as in the conventional art, necessity of raising a drying temperature to a heat-resistant temperature of the support or higher is caused in the drying step, and therefore strong curling occurs on the composite due to crosswise shrinkage of the support in association with drying of the facilitated transport membrane. However, according to the method of producing of the present disclosure, the thick membrane is gradually formed a plurality of times in the coating and drying step, and therefore occurrence of curling can be suppressed.

### BRIEF DESCRIPTION OF THE DRAWINGS

FIG. 1 is a diagram showing a production process in a method of producing a composite for acid gas separation as related to the present disclosure.

FIG. 2 is a diagram, subsequent to FIG. 1, showing a production process in the method of producing the composite for acid gas separation.

FIG. 3 is a diagram, subsequent to FIG. 2, showing a production process in the method of producing the composite for acid gas separation.

FIG. 4 is a diagram, subsequent to FIG. 3, showing a production process in the method of producing the composite for acid gas separation.

FIG. 5 is a diagram, subsequent to FIG. 4, showing a production process in the method of producing the composite for acid gas separation.

FIG. 6 is a schematic view showing an example of structure of a production apparatus used in the method of producing the composite for acid gas separation as related to the present disclosure.

FIG. 7 is a partially cut-away schematic structural view showing one embodiment of an acid gas separation module to which a composite for acid gas separation produced by the production method of the present disclosure is applied.

### DETAILED DESCRIPTION OF THE PREFERRED EMBODIMENTS

Embodiments of the present disclosure are described below, referring to drawings.

### <Method of Producing Composite for Acid Gas Separation>

A method of producing a composite for acid gas separation of the present disclosure includes a coating liquid preparation step for preparing a coating liquid for formation of an acid gas separation facilitated transport membrane, the coating liquid containing a hydrophilic compound, an acid gas carrier and water; an initial layer formation step for forming a first acid gas separation facilitated transport membrane by using as a porous support a laminated membrane between a hydrophobic porous membrane and an auxiliary support membrane, coating on a surface of the hydrophobic porous membrane of the laminated membrane the coating liquid for formation at a liquid membrane thickness of 0.3 mm or more and 1.0 mm or less, and drying the coated liquid membrane; and a next layer formation step one or more times for forming a next acid gas separation facilitated transport membrane by further coating on the previously formed acid gas separation facilitated transport membrane the coating liquid for formation of the acid gas separation facilitated transport membrane, and drying the coated liquid membrane.

The porous support has a role of supporting the acid gas separation facilitated transport membrane, and has acid gas permeability, on which the composition (coating liquid) for formation of the acid gas separation facilitated transport membrane can be coated to form the acid gas separation facilitated transport membrane, and further the support can support the membrane.

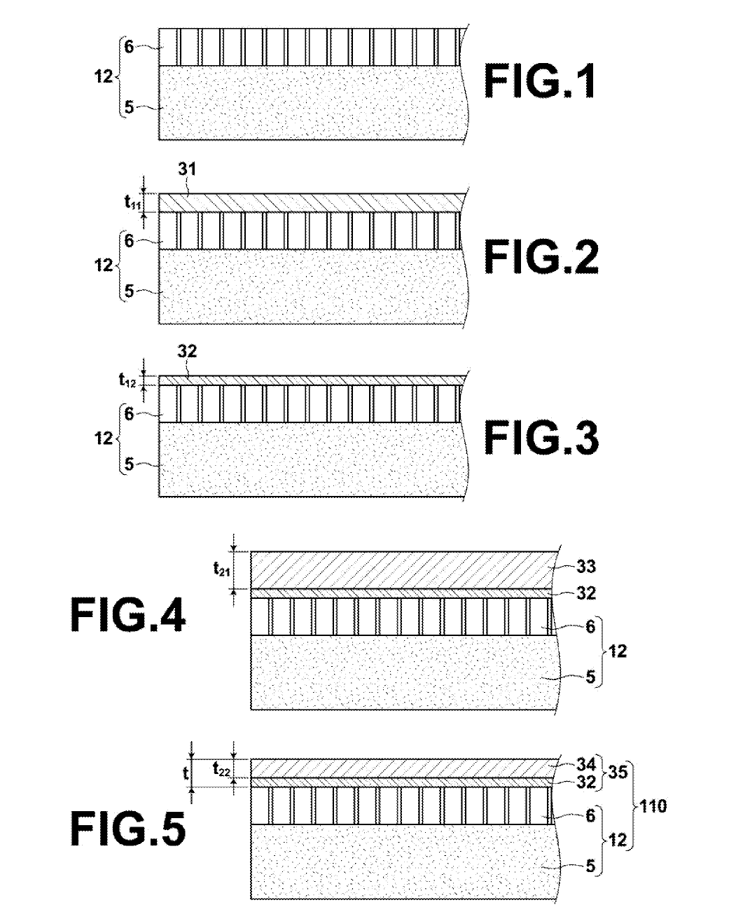

Here, as shown in FIG. 1, as a support 12, a laminated membrane between a hydrophobic porous membrane 6 and an auxiliary support membrane 5 for supporting the porous membrane 6 is used.

The composite for acid gas separation of the present disclosure has a function of separating at least one kind of acid gas from a gas mixture containing at least one kind of acid gas and at least one kind of non-acid gas. Here, specific examples of the acid gas include carbon dioxide, hydrogen sulfide, carbonyl sulfide, sulfur oxides (SOₓ) and nitrogen oxides (NOₓ). Specific examples of the non-acid gas include hydrogen, methane, nitrogen and carbon monoxide.

In particular, the composite is preferred when carbon dioxide is separated from an original gas mainly containing carbon dioxide and methane or when carbon dioxide is separated from an original gas mainly containing carbon dioxide and hydrogen.

The porous support has a role of supporting the acid gas separation facilitated transport membrane, and has acid gas permeability, on which the composition (coating liquid) for formation of the acid gas separation facilitated transport membrane can be coated to form the acid gas separation facilitated transport membrane, and further the support can support the membrane.

Here, as shown in FIG. 1, as the support 12, the laminated membrane in which the hydrophobic porous membrane 6 and the auxiliary support membrane 5 are laminated and formed is used.

As the porous membrane 6, a membrane of membrane filter of polysulfone or cellulose, an interfacial-polymerization thin membrane of polyamide or polyimide, or a stretched porous membrane of polytetrafluoroethylene or high-molecular-weight polyethylene is preferred from viewpoints of high porosity, only limited inhibition of diffusion of the acid gas (particularly carbon dioxide), strength, production adaptability or the like. Moreover, the porous membrane 6 is preferably formed of a raw material having heat resistance and low hydrolyzability. Above all, a stretched membrane of polytetrafluoroethylene (PTFE) is particularly preferred.

The porous membrane 6 is designed to have hydrophobicity in order to prevent the facilitated transport membrane containing moisture under a use environment from easily penetrating into a porous portion to cause neither a membrane thickness distribution nor performance deterioration over time. A maximum pore diameter of pores is preferably 1 μm or less.

Moreover, from viewpoints of sufficiently penetrating an adhesive into an adhesive coating region, and causing no hindrance of gas passage in a region through which the gas is passed, an average pore diameter of the pores in the porous membrane is preferably 0.001 μm or more and 10 μm or less, further preferably 0.002 μm or more and 5 μm or less, and particularly preferably 0.005 μm or more and 1 μm or less.

Here, the maximum pore diameter is to mean a value measured and calculated by a bubble point method. The pore diameter can be measured by the bubble point method (in accordance with JIS K 3832), for example by using as a measurement instrument Perm Porometer manufactured by PMI, Inc.

The auxiliary support membrane 5 is provided for reinforcement of the porous membrane 6, and is not particularly limited, as long as strength, stretching resistance and gas permeability are satisfactory, and a nonwoven fabric, a woven fabric, a net, a mesh having an average pore diameter of 0.001 μm or more and 10 μm or less can be appropriately selected and used.

In a manner similar to the already-described porous membrane 6, the auxiliary support membrane 5 is also preferably formed of a raw material having heat resistance and only limited hydrolyzability. As fibers that form the nonwoven fabric, the woven fabric or a knitted fabric, such fibers are preferred as formed of a polyolefin base having excellent durability and heat resistance, such as polypropylene, modified polyamide such as Aramid (trade name) or a fluorine-containing resin such as polytetrafluoroethylene and polyvinylidene fluoride. As a resin material that forms the mesh, a similar raw material is also preferably used.

Among the above materials, the nonwoven fabric formed of polypropylene (PP) that is inexpensive and has strong mechanical strength is particularly preferred.

The mechanical strength can be improved by having the auxiliary support membrane 5. Therefore, even if handling is performed in the roll-to-roll coating device, an effect of causing no wrinkling on the support membrane or the like is found, and thus productivity can also be improved.

In addition, as the support 12, PTFE is particularly preferably used as the hydrophobic porous membrane 6 and the nonwoven fabric formed of polypropylene (PP) that is inexpensive and has high mechanical strength is particularly preferably used as the auxiliary support membrane 5.

The hydrophobic porous membrane means that a surface of the porous membrane on a side in contact with the facilitated transport membrane is a hydrophobic surface. If the surface is hydrophilic, the facilitated transport membrane into which moisture is incorporated is easily penetrated into a porous portion under a use environment to have an anxiety of causing a thickness distribution or performance deterioration over time. Here, hydrophobicity means that a contact angle with water at room temperature (25° C.) is about 80° or higher.

If the support 12 is too thin, the strength is imperfect. A thickness of porous membrane is preferably about 5 to 100 μm and a thickness of an auxiliary support membrane is preferably about 50 to 300 μm.

Step for preparing Coating Liquid for Formation of Acid Gas Separating Layer

In the coating liquid preparation step, the coating liquid for formation of the acid gas separating layer, the coating liquid containing the hydrophilic compound, the acid gas carrier and water, is prepared.

In preparation of the coating liquid, the hydrophilic polymer being the hydrophilic compound and a carbon dioxide carrier, and when necessary, other additives including the thickener and the crosslinking agent are added to water (ordinary temperature water or warmed water) in an appropriate amount, respectively, and sufficiently stirred, and when necessary, heated while being stirred to promote dissolution. In addition, the hydrophilic polymer and the acid gas carrier may be separately added to water, or a previously mixed material may be added thereto. For example, when the thickener is incorporated thereinto, the thickener is added to water and dissolved thereinto, and then the hydrophilic polymer and the acid gas carrier are gradually added thereto, and stirred. Thus, precipitation (salting-out) of the hydrophilic polymer or the thickener can be effectively prevented.

In addition, during coating, a temperature of the coating liquid is adjusted to 15° C. or higher and 35° C. or lower, and a measured value at the temperature and at 60 rpm in a B type viscometer is adjusted to 0.5 Pa·s or more and 5 Pa·s or less.

The viscosity of the coating liquid before application is adjusted to 0.5 Pa·s or more and 3 Pa·s or less (500 to 3,000 cp). In addition, from viewpoints of surface properties after coating or a high speed, the viscosity is preferably 0.5 Pa·s or more and 2 Pa·s or less (500 to 2,000 cp), and further preferably 1 Pa·s or more and 2 Pa·s or less (1,000 to 2,000 cp). The viscosity on the above occasion is expressed in terms of a value at 60 rpm and a liquid temperature of 25° C. in the B type viscometer. If the viscosity is 0.5 Pa·s or more, flow of the membrane after coating can be suppressed to attain a uniform membrane thickness. In general, if temperature is high, the viscosity decreases, and if the temperature decreases, the viscosity increases. Here, if the viscosity is within the above-described viscosity range at the liquid temperature of 25° C., the viscosity has a meaning of being suitable for coating under an ordinary environment (about 10° C. to 35° C.).

Whether or not the thus prepared coating liquid for formation of the acid gas separation facilitated transport membrane shows any of viscosity, at any of temperatures within the range of 15° C. or higher and 35° C. or lower, in the range of 0.5 Pa·s or more and 5 Pa·s or less in the measured value of viscosity at 60 rpm in the number of revolutions in B type viscosity measurement can be confirmed as described below.

More specifically, the prepared coating liquid for formation of the acid gas separation facilitated transport membrane is charged into a stainless-steel vessel (for example, inner diameter: 4 cm, height: 12 cm) in which a viscometer cylinder (rotor) is adjusted to be sufficiently immersed into the coating liquid. The above-described stainless-steel vessel is immersed into a temperature-adjustable water bath, and while a temperature of the charged coating liquid is adjusted in the range of 15° C. to 35° C., a B type viscometer (manufactured by Tech-Jam Co., Ltd., BL2 1 to 100,000 mPa·s/KN3312481) is operated to read a value for each temperature at 60 rpm in the number of revolutions, and the viscosity of the coating liquid is measured in accordance with JIS Z 8803.

### Initial Layer Formation Step And Next Layer Formation Step

The method of producing the composite for acid gas separation of the present disclosure is suitable for production by a coater according to the roll-to-roll process in which a belt-shaped (web-shaped) support is used in coating of the coating liquid and in the drying step.

The method for coating the coating liquid is not particularly limited, as long as the coating liquid can be coated at the above-described viscosity. The viscosity is high and the thickness is large, and therefore post-measuring methods such as a roll coating method and a blade coating method are most suitable, in which a large amount of the coating liquid is transported onto the support immediately before the coating, and then the thickness is adjusted to a desired level by using a mechanism described later. As other coating methods, an extrusion coating method, a dip coating method, a bar coating method, a curtain coating method or the like may be adopted. Moreover, a plurality of coating methods may be combined. A roll coating method and a blade coating method are preferred in view of inexpensiveness in production facilities.

In the initial layer formation step, as shown in FIG. 2, the prepared coating liquid for formation of the acid gas separation facilitated transport membrane is coated as a liquid membrane 31 onto a surface of the hydrophobic porous membrane 6 of the porous support 12 so as to be 0.3 mm or more and 1.0 mm or less in a thickness t₁₁, and dried. Thus, as shown in a FIG. 3, an acid gas separation facilitated transport membrane 32 is formed on the porous support 12. On the above occasion, the acid gas separation facilitated transport membrane 32 is formed in drying of the liquid membrane 31, and therefore a thickness tie becomes smaller than the liquid membrane 31 thickness. The thickness t₁₂ is preferably 5 to 20 μm.

The thickness during coating the liquid membrane is adjusted to 0.3 mm or more. Thus, the coating liquid can be coated in the form of the membrane even during coating the liquid onto a surface of the hydrophobic porous membrane. Moreover, the liquid membrane thickness is adjusted to 1.0 mm or less. Thus, a drying load (period of time as related to drying) can be suppressed to increase a rate of application. In the initial layer formation step, the liquid membrane thickness during coating is preferably adjusted to 0.3 mm or more and 0.7 mm or less, and further preferably 0.3 mm or more and 0.5 mm or less.

The liquid membrane thickness herein basically means a set value on a side of the coating device (applicator). In addition, the liquid membrane thickness after passing a position in which the liquid membrane thickness is set by the coating device is different from the liquid membrane thickness set by the coating device.

In the drying step, the coated liquid membrane is dried in a drying oven to form the acid gas facilitated transport membrane. Here, “drying” means removal of at least part of moisture contained in the liquid membrane of the coating liquid for formation of the acid gas separation facilitated transport membrane formed on the support in the coating step. However, when the support on which the facilitated transport membrane is formed is required to be wound around a winding roll according to the roll-to-roll process, a coated surface is to be ordinarily brought into contact with a conveying roll. Therefore, in order to avoid occurrence of problems of deformation of the facilitated transport membrane or partial sticking of the membrane onto the roll during contact with the conveying roll, “drying” is required until a moisture content in the facilitated transport membrane is decreased to about 20% or less. Here, when a mass of a 10 cm-square facilitated transport membrane under an environment of a dew point of −20° C. is taken as A, and a mass of a 10 cm-square facilitated transport membrane at 25° C. under an environment of a relative humidity of 20% is taken as B, the moisture content is expressed in terms of a value calculated according to the following formula:

(B−A)/B×100.

A temperature in the drying oven is preferably appropriately determined in the range of 60 to 120° C. If the temperature is 60° C. or higher, a drying time can be suppressed within a practical time. On the other hand, the temperature on a high temperature side can be appropriately determined mainly according to heat resistance of the support, and is adjusted to about 120° C. herein.

In addition, in view of stability of a membrane surface, the temperature in the drying oven is preferably 60 to 90° C., and further preferably 70 to 80° C. As drying methods, various kinds of drying methods such as a drying method using warm air and a drying method using an infrared heater can be applied. As long as the temperature inside the drying oven is 60 to 120° C., temperature uniformity is not always required. In order to reduce defects due to formation of a surface coat during drying, a temperature in an initial drying zone is preferably set to be lower in comparison with a latter drying zone. Moreover, the temperature is further preferably set to be gradually increased from a side of an inlet of the drying oven toward a side of an outlet (discharge port) of the drying oven. For example, the temperature is set to 60° C. in the vicinity of the inlet of the drying oven being the initial drying zone, to 70° C. in the vicinity of a center of the drying oven serving as a middle drying zone, to 90° C. in the vicinity of the outlet of the drying oven being the latter drying zone, or the like.

### Next Layer Formation Step

In the next layer formation step, as shown in FIG. 4, the coating liquid for formation of the acid gas separation facilitated transport membrane is coated onto the previously formed acid gas separation facilitated transport membrane 32, and then dried. Thus, as shown in FIG. 5, an acid gas separation facilitated transport membrane 34 is formed. In a manner similar to the case of the initial layer formation, a thickness t₂₂ of the facilitated transport membrane 34 after drying becomes smaller than the thickness t₂₁ of the liquid membrane during being coated.

The next layer formation step is performed one or more times after the initial layer formation step, and may be performed only once or repeatedly two or more times. More specifically, onto the acid gas separation facilitated transport membrane 34 shown in FIG. 5, the next layer formation step may be further performed. When the next layer formation step is performed a plurality of times, a thickness of the coating liquid membrane, drying conditions or the like may be identical to or different from each other.

Through the next layer formation step once or a plurality of times, a composite 110 for acid gas separation (see FIG. 5) can be obtained, including formation of the acid gas separation facilitated transport membrane 35 on the support 12.

A thickness t of the acid gas separation facilitated transport membrane composed of a plurality of layers is preferably in the range of 40 μm to 100 μm under an environment of 25° C. and 30% RH.

In the next layer formation step, a thickness t₂₁ of the liquid membrane to be coated is preferably adjusted to 3.0 mm or less. Then, t₂₁ of the liquid membrane is adjusted to 3.0 mm or less. Thus, occurrence of skin burr on the surface or the like in the drying step can be suppressed to obtain a membrane having a smooth surface. Because the facilitated transport membrane having a sufficient thickness can be efficiently produced and a satisfactory membrane can be obtained, the liquid membrane thickness to be coated in the next layer formation step is preferably 2.0 mm or more and 3.0 mm or less.

In addition, in order to adjust the thickness, a thin liquid membrane layer having about 0.3 mm may be coated in the next layer formation step in several cases.

Drying in the next layer formation step is performed in a manner similar to drying in the initial layer formation step. However, when the liquid membrane having a thickness exceeding 1.0 mm, which thickness is larger than the thickness of the initial layer, is coated in the next layer formation step, rapid drying is performed to easily cause dry faults on the surface, such as mottles and unevenness. Accordingly, drying in the next layer formation step is further preferably performed at a temperature lower than the temperature during drying in the initial layer formation step.

According to the method of producing the composite for acid gas separation of the present disclosure, the acid gas separation facilitated transport membrane is formed through the coating and drying step a plurality of times. Therefore, the acid gas separation facilitated transport membrane having a larger thickness can be obtained. The composite has the acid gas separation facilitated transport membrane having the large thickness. Thus, permeability of a gas other than a predetermined acid gas contained in a feed gas (original gas) can be sufficiently reduced.

In a production apparatus according to the Roll-to-Roll process using a belt-shaped (web-shaped) support, a high performance composite for acid gas separation, the composite having only a limited number of membrane defects, can be produced by the method with high production efficiency and at low production cost.

In addition, the above description is made in the form of an embodiment, in which, in the step for preparing the coating liquid for formation of the acid gas separation facilitated transport membrane, one kind of the coating liquid is prepared and an identical coating liquid is applied in a plurality of times. However, such modification may be made, in which, in the step for preparing the coating liquid for formation, a plurality of coating liquids for formation in which the concentrations of the acid gas carrier are different are prepared, and in the next layer formation step, the coating liquid for formation in which the concentrations of the acid gas carrier is different from the concentration of the above-described coating liquid for formation upon forming the previously formed acid gas separation facilitated transport membrane is used to form the next layer acid gas separation facilitated transport membrane. On the above occasion, in the next layer formation step, the coating liquid for formation is preferably used, in which the concentration of the acid gas carrier is lower than the concentration in the coating liquid for formation upon forming the previously formed acid gas separation facilitated transport membrane.

When metal carbonate is used as the acid gas carrier, the acid gas separation facilitated transport membrane contains a large amount of metal carbonate in the membrane. Therefore, even in the membrane after drying, crystals of metal carbonate are easily precipitated on the membrane surface due to a slight amount of moisture or a change of moisture content caused by a change of temperature and humidity during storage of the membrane. Therefore, the concentration of the carrier in the membrane to be formed on an upmost layer is reduced. Thus, precipitation of the carrier onto the surface can be delayed, and such a case is preferred.

Further, in the coating liquid preparation step, as the coating liquid for formation of the acid gas separation facilitated transport membrane, a plurality of coating liquids for formation in which the hydrophilic compounds are different are prepared, and in the next layer formation step, such an acid gas separation facilitated transport membrane may be formed in which a hydrophilic compound is different from the compound in the previously formed coating liquid for formation upon forming the acid gas separation facilitated transport membrane. For example, when the hydrophilic compound in the coating liquid for formation of the first acid gas separation facilitated transport membrane is a polyvinyl alcohol-polyacrylic acid copolymer, as the coating liquid for formation of the acid gas separation facilitated transport membrane for the next layer, a hydrophilic compound containing a polyvinyl alcohol-polyacrylic acid copolymer in which a copolymerization ratio is different may be used.

In addition, in the step for preparing the coating liquid for formation of the acid gas separation facilitated transport membrane, a coating liquid for formation, in which amounts of addition of a thickener, an additives or the like are different, may be prepared, and a different coating liquid for formation may be used between the time during forming the first acid gas separation facilitated transport membrane and the time during forming the next acid gas separation facilitated transport membrane. Furthermore, coating liquids for formation, in which a plurality of concentrations of the acid gas carrier, concentrations of the hydrophilic compound and concentrations of amounts of addition of the thickener, the additive or the like are different, may be prepared, and a different coating liquids for formation may be used between the time during forming the first acid gas separation facilitated transport membrane and the time during forming the next acid gas separation facilitated transport membrane.

When three or more layers of the acid gas separation facilitated transport membrane are coated and formed, a first layer and a second layer may be formed by using the identical coating liquid for formation, and a third layer may be formed by using a different coating liquid for formation.

### <Apparatus for Producing Composite for Acid Gas Separation>

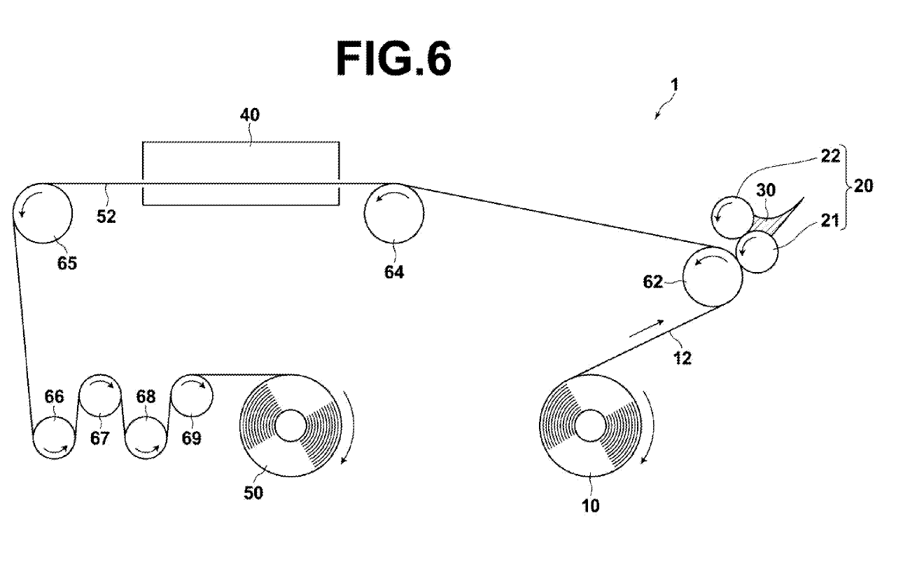

One embodiment of the production apparatus related to the embodiment of the present disclosure for carrying out the method of producing the composite for acid gas separation of the present disclosure is described by using FIG. 6.

FIG. 6 schematically shows one example of apparatus structure used in a process for producing the composite for acid gas separation as related to the present disclosure. This apparatus 100 is equipped with a coating unit having a feeding roll 10 for feeding a belt-shaped support 12, and a coater 20 for coating onto the support 12 a coating liquid 30 for formation of an acid gas separation layer (in FIG. 6, a three-roll coater composed of an applicator roll 21, a metering roll 22 and a backup roll 62 also serving as a roll for conveying the belt-shaped support 12, rotating in an arrow direction in the figure), a drying unit equipped with a drying oven 40 for drying a liquid membrane (not shown) of the coating liquid 30 formed on the support 12, and a winding step unit equipped with a winding roll 50 for winding the thus obtained composite 52 for acid gas separation. Moreover, in each unit 20, 40 or 50, a conveying roll 62 (in FIG. 6, functioning also as the backup roll of the roll coater), and rolls 64 to 69 for conveying the support 12 are arranged.

The apparatus 100 having such structure is used. Thus, according to Roll-to-Roll, more specifically, the support 12 is fed from the feeding roll 10, and while the support 12 is conveyed, the coating step and the drying step are sequentially performed, and the support 52 on which the facilitated transport membrane is formed can be wound around the winding roll 50, and the facilitated transport membrane can be continuously and efficiently formed.

With regard to a rate of conveyance of the support 12, although a level depends on a kind of the support 12, a viscosity of the composition (coating liquid) or the like, if the rate of conveyance of the support is too high, uniformity of thickness of the coated membrane in the coating step is liable to reduce, and if the rate is too low, productivity reduces. The rate of conveyance of the support 12 may be determined according to the kind of the support 12, the viscosity of the composition or the like also in consideration of the above-described points, and the rate is preferably 1 m/min or more, and further preferably 5 m/min or more and 100 m/min or less.

In the initial layer formation step and the next layer formation step, such a method is simplest, in which the initial layer formation step is performed in the production apparatus 1 as shown in FIG. 6, and a rolled article once wound is again set onto a feeding side of the identical coater to perform the next layer formation step.

Meanwhile, a coater equipped with a plurality of coating units and drying ovens to perform the next layer formation without winding after the initial layer is formed.

In the production apparatus 1, the belt-shaped support 12 is fed from the feeding roll 10 to be conveyed to a coater 20 in the coating unit, and the above-described coating liquid is coated onto the support 12, at a temperature of 15° C. or higher and 35° C. or lower, and at a viscosity of 0.5 Pa·s or more and 5 or less Pa·s in a measured value of viscosity at 60 rpm in the number of revolutions in B type viscosity measurement to form the liquid membrane of the above-described coating liquid on the support 12. If at least one of the temperature and the viscosity of the coating liquid in the coating step is deviated from the above-described range, sedimentation is liable to be caused in the liquid membrane of the above-described coating liquid, the coating liquid 30 on the coater 20 of the coating device is liable to flow out, the hydrophilic polymer is liable to precipitate (salt out) to cause difficulty in coating onto the support, and a fluctuation in thickness is liable to become large.

As a coater for coating the coating liquid as related to the present disclosure onto the support, a roll coater or blade coater is particularly preferred.

The roll coater is the coater formed of a singular roll or in combination of a plurality of rolls to control an amount of the coating liquid to be held on a surface of a roll (applicator roll) arranged in a position nearest to the support and to transport an amount at a predetermined ratio of the coating liquid on the (applicator roll) onto a surface of the support.

Specific examples of a preferred roll coater include a direct gravure coater, an offset gravure coater, a one-roll kiss coater, a three-reverse roll coater and a normal rotation roll coater, and a three-reverse roll coater is preferred, in which the coater is suitable for coating of the coating liquid having middle viscosity to high viscosity of 0.5 Pa·s or more to 5 Pa·s or less in the measured value of viscosity at 60 rpm in the number of revolutions in B type viscosity measurement.

The blade coater is the coater for coating an excessive amount of the coating liquid onto the support, and then scraping off an excessive portion of the coating liquid on the support by using a blade.

In the drying oven 40 in the production apparatus 1, at least part of water is removed, the water being the solvent contained in the coated membrane of the coating liquid for formation of carbon dioxide separating layer formed on the support in the coating step. Such a drying step is performed by heating the support on which the coated membrane is held, blowing dry air onto the coated membrane, or both thereof.

In order to avoid occurrence of deformation or the like of the support and to allow rapid drying of the liquid membrane of the coating liquid, a temperature in the drying oven is preferably set in the range of 60° C. or higher and 120° C. or lower. The temperature is adjusted preferably to 60° C. or higher and 90° C. or lower, and further preferably to 70° C. or higher and 80° C. or lower.

A surface of the formed facilitated transport membrane is brought into contact with rolls 67, 69 among the conveying rolls provided from an outlet of the drying oven 40 to the winding roll 50, the facilitated transport membrane is required to be dried to a degree at which, when the membrane is brought into contact with the roll, no facilitated transport membrane is adhered onto the roll to cause no dirt on the roll and no defects on the surface of the surface of the facilitated transport membrane. In addition, in the apparatus according to the roll-to-roll process, as a conveying roll, a conveying roll in contact with the coated is essential in order to absorb feeding and winding rates (peripheral velocity) or adjust tension.

Next, the coating liquid for formation of the acid gas separation facilitated transport membrane is described in detail.

In a preferred embodiment of the present disclosure, in the coating step, the coating liquid for formation of the acid gas separation facilitated transport membrane is coated onto the support, in the range of 15° C. or higher and 35° C. or lower and at a viscosity of 0.5 Pa·s or more and 5 Pa·s or less in the measured value of viscosity at 60 rpm in the number of revolutions in B type viscosity measurement. In a particularly preferred embodiment, the coating liquid is coated onto the support, in the range of 15° C. or higher and 35° C. or lower and at a viscosity of 1 Pa·s or more and 5 Pa·s or less in the measured value of viscosity at 60 rpm in the number of revolutions in B type viscosity measurement. Thus, the acid gas separation facilitated transport membrane having no defects such as no mixing of air bubbles, and having a uniform membrane thickness is markedly easily and stably obtained.

### (Hydrophilic Compound)

Specific examples of the hydrophilic compound contained in the coating liquid include a hydrophilic polymer. The hydrophilic polymer functions as a binder, and the hydrophilic polymer holds moisture in the acid gas separation facilitated transport membrane to exhibit a function of separating the acid gas by the acid gas carrier. From a viewpoint of the acid gas separation facilitated transport membrane preferably having high water absorptivity (water retention), the hydrophilic polymer preferably has high water absorptivity, and in terms of an amount of water absorption of a physiological salt solution, has an absorptivity of preferably 0.5 g/g or more, further preferably 1 g/g or more, still further preferably 5 g/g more or more, still further preferably 10 g/g or more, and particularly preferably 20 g/g or more.

As the hydrophilic polymer contained in the coating liquid, a publicly known hydrophilic macromolecule can be used. However, from viewpoints of water absorptivity, membrane-forming properties, strength and so forth, for example, polyvinyl alcohols, polyacrylic acids, polyethylene oxides, water-soluble celluloses, starches, alginic acids, chitins, polysulfonic acids, polyhydroxy methacrylates, polyvinyl pyrrolidones, poly-N-vinylacetamides, polyacrylamides, polyethyleneimines, polyallylamines, polyvinyl amines and so forth are preferred, and a copolymer thereof can also be preferably used.

A polyvinyl alcohol-polyacrylate copolymer is particularly preferred. The polyvinyl alcohol-polyacrylate copolymer has a high water absorption capability, and also strength of hydrogel thereof is large even during high water absorption. A content of polyacrylate in the polyvinyl alcohol-polyacrylate copolymer is 1 to 95 mol %, preferably 2 to 70 mol %, further preferably 3 to 60 mol %, and particularly preferably 5 to 50 mol %, for example. Specific examples of the polyacrylate include alkali metal salt such as sodium salt and potassium salt, and also ammonium salt and organic ammonium salt.

Specific examples of a commercially available polyvinyl alcohol-polyacrylate copolymer (sodium salt) include Kurastomer AP20 (trade name: manufactured by Kuraray Co., Ltd.).

Moreover, two or more kinds of the hydrophilic polymers may be mixed and used.

As a content of the hydrophilic polymer in the coating liquid, although a level depends on a kind thereof, from viewpoints of forming the membrane as the binder and providing the acid gas separation facilitated transport membrane with a capability of sufficiently holding moisture, the content is preferably 0.5 mass % or more and 50 mass % or less, further preferably 1 mass % or more and 30 mass % or less, and particularly preferably 2 mass % or more and 15 mass % or less.

### (Acid Gas Carrier)

The acid gas carrier means a substance that indirectly reacts with the acid gas, or a substance per se that directly reacts with the acid gas. As the acid gas carrier, various kinds of water-soluble inorganic and organic substances that show basicity are used. Specific examples of the substance that indirectly reacts with the acid gas include a substance that reacts with other gases contained in a fed gas to show basicity, in which the resultant basic compound reacts with the acid gas. More specifically, the acid gas carrier means such an alkali metal compound that reacts with a water vapor to release OH⁻, in which the resultant OH⁻ reacts with CO₂ to allow selective incorporation of CO₂ into the membrane. Specific examples of the substance that directly reacts with the acid gas include such a substance per se being basic as a nitrogen-containing compound and sulfur oxide.

Specific examples of the alkali metal compound include at least one kind selected from alkali metal carbonate, alkali metal bicarbonate or alkali metal hydroxide. Here, as the alkali metal, an alkali metal element selected from cesium, rubidium, potassium, lithium and sodium is preferably used.

In addition, the alkali metal compound herein is used in the meaning of not only the alkali metal per se, but also including salt and ion thereof.

Specific examples of the alkali metal carbonate include lithium carbonate, sodium carbonate, potassium carbonate, rubidium carbonate and cesium carbonate.

Specific examples of the alkali metal bicarbonate include lithium hydrogen carbonate, sodium hydrogen carbonate, potassium hydrogen carbonate, rubidium hydrogen carbonate and cesium hydrogen carbonate.

Specific examples of the alkali metal hydroxide include lithium hydroxide, sodium hydroxide, potassium hydroxide, cesium hydroxide and rubidium hydroxide.

Above all, alkali metal carbonate is preferred, and a compound containing cesium, rubidium or potassium, the compound having high solubility in water, is preferred. Moreover, two or more kinds of acid gas carriers may be mixed and used. Specific examples preferably include a mixture of cesium carbonate and potassium carbonate.

As the nitrogen-containing compound, for example, such a compound can be used as amino acids including glycine, alanine, serine, proline, histidine, taurine and diaminopropionic acid, hetero compounds including pyridine, histidine, piperazine, imidazole and triazine, alkanolamines including monoethanolamine, diethanolamine, triethanolamine, monopropanolamine, dipropanolamine and tripropanolamine, cyclic polyetheramines including cryptand[2.1] and cryptand[2.2], bicyclic type polyetheramines including cryptand[2.2.1] and cryptand[2.2.2], and porphyrin, phthalocyanine and ethylenediaminetetraacetic acid.

As the sulfur compound, such a compound can be used as amino acids including cystine and cysteine, polythiophene and dodecylthiol.

As a content of the acid gas carrier in the coating liquid, although a level depends on a kind thereof, in order to prevent salting out before coating, and simultaneously to positively exhibit a function of separating the acid gas, the content is preferably 0.3 to 30 mass %, further preferably 0.5 to 25 mass %, and particularly preferably 1 to 20 mass %.

The coating liquid contains the hydrophilic polymer and the acid gas carrier preferably in the mass ratio of 1:9 or more and 2:3 or less, further preferably in the range of 1:4 or more and 2:3 or less, and still further preferably in the range of 3:7 or more and 2:3 or less.

### (Thickener)

A thickener may be further used in the coating liquid composition for the purpose of adjusting the viscosity within the temperature range of 15° C. or higher and 35° C. or lower for the coating liquid composition for formation of the acid gas separation facilitated transport membrane composed of the hydrophilic polymer, the acid gas carrier and water, and containing the hydrophilic polymer and the acid gas carrier in the mass ratio of 1:9 or more and 2:3 or less.

Any of the thickener may be used, as long the thickener is a compound that may increase the viscosity of the coating liquid composition within the temperature range of 15° C. or higher and 35° C. or lower. For example, a polysaccharide thickener such as agar, carboxymethylcellulose, carrageenan, xanthan gum, guar gum and pectin is preferred, and in view of membrane-forming properties, ease of availability and cost, carboxymethylcellulose is preferred.

Carboxymethylcellulose that can be preferably used is in the range of 0.6 or more and 1.5 or less in a degree of etherification, and in the range of 1 Pa·s or more and 10 Pa·s or less in the measured value of viscosity at 60 rpm in the number of revolutions in B type viscosity measurement when carboxymethylcellulose is formed into a 1 mass % aqueous solution. If such carboxymethylcellulose is used, the coating liquid composition for formation of the acid gas separation facilitated transport membrane, the composition showing desired viscosity at a small content, is easily obtained, and also has a low risk of causing precipitation due to an incapability of dissolution into the coating liquid at least part of components other than a solvent contained in the coating liquid.

Such carboxymethylcellulose is available from a commercial item, and specific preferred examples include CMC2280 manufactured by Daicel FineChem Ltd.

A content of the thickener in the composition (coating liquid) is preferably as small as possible, as long as adjustment can be made so as to show any of viscosity, at any of temperatures within the range of 15° C. or higher and 35° C. or lower, within the range of 0.5 Pa·s or more and 5 Pa·s or less in the measured value of viscosity at 60 rpm in the number of revolutions in B type viscosity measurement. As a general indication, the content is preferably 10 mass % or less, further preferably 0.1 mass % or more and 5 mass % or less, and most preferably 0.1 mass % or more and 2 mass % or less.

### (Crosslinking Agent)

Crosslinking of the hydrophilic polymer can be performed by a publicly known technique such as thermal crosslinking, ultraviolet crosslinking, electron-beam crosslinking and radiation crosslinking. The composition of the present disclosure preferably contains a crosslinking agent. In particular, the composition preferably contains a crosslinking agent having two or more functional groups that can react with a polyvinyl alcohol-polyacrylate copolymer and can be thermally crosslinked. Specific examples of the crosslinking agent include polyvalent glycidyl ether, polyhydric alcohol, polyvalent isocyanate, polyvalent aziridine, a haloepoxy compound, polyvalent aldehyde and polyvalent amine.

Here, specific examples of the above-described polyvalent glycidyl ether include ethylene glycol diglycidyl ether, polyethylene glycol diglycidyl ether, glycerol polyglycidyl ether, diglycerol polyglycidyl ether, polyglycerol polyglycidyl ether, sorbitol polyglycidyl ether, pentaerythritol polyglycidyl ether, propylene glycol glycidyl ether and polypropylene glycol diglycidyl ether.

Specific examples of the above-described polyhydric alcohol include ethylene glycol, diethylene glycol, triethylene glycol, tetraethylene glycol, polyethylene glycol glycerol, polyglycerol, propylene glycol, diethanolamine, triethanolamine, polyoxypropyl, an oxyethylene-oxypropylene block copolymer, pentaerythritol and sorbitol.

Specific examples of the above-described polyvalent isocyanate include 2,4-toluylenediisocyanate and hexamethylene diisocyanate. Moreover, specific examples of the above-described polyvalent aziridine include 2,2-bishydroxymethylbutanol-tris[3-(1-aziridinyl)propionate], 1,6-hexamethylenediethylene urea and diphenylmethane-bis-4,4′-N,N′-diethylene urea.

Specific examples of the above-described haloepoxy compound include epichlorohydrin and α-methylchlorohydrin.

Specific examples of the above-described polyvalent aldehyde include glutaraldehyde and glyoxal.

Specific examples of the above-described polyvalent amine include ethylenediamine, diethylenetriamine, triethylenetetramine, tetraethylenepentamine, pentaethylenehexamine and polyethyleneimine.

Among the above-described crosslinking agents, as a thermal crosslinking agent for the polyvinyl alcohol-polyacrylate copolymer, glutaraldehyde is particularly preferred.

### (Other Components)

The coating liquid can contain one or more components (additives) other than the hydrophilic polymer, the carbon dioxide carrier and the thickener within the range in which coating properties or gas separation characteristics are not adversely affected. Specific examples of other components include the above-mentioned crosslinking agent, and also a surfactant, a catalyst, a moistening (water absorbent) agent, an auxiliary solvent, a membrane strength regulator and a defect detection agent.

A specific module for acid gas separation to which the composite for acid gas separation produced by the production method of the present disclosure is applied is described below.

### <Spiral Type Module for Acid Gas Separation>

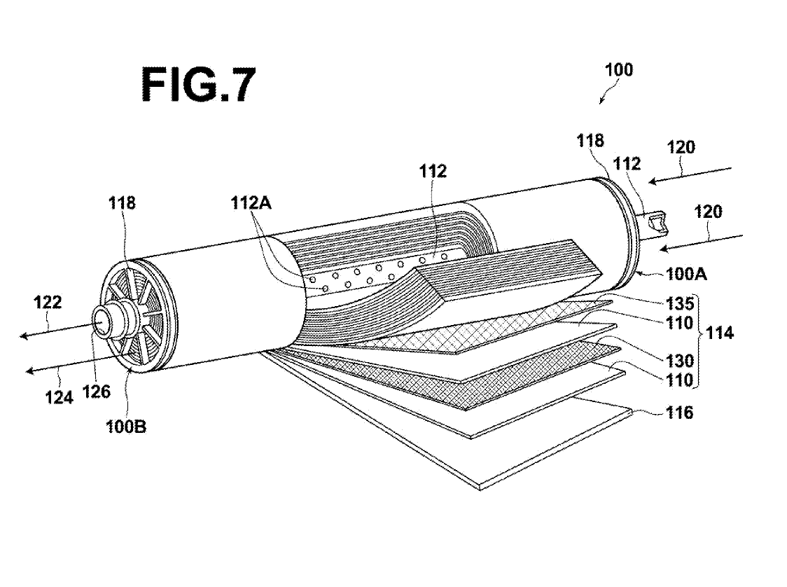

FIG. 7 is a partially cutaway schematic structural view showing a spiral type module 100 for acid gas separation, the module 100 being a first embodiment of the module for acid gas separation of the present disclosure.

As shown in FIG. 7, the acid gas separation module 100 is structured as basic structure such that, in a state in which a singular laminate 114 or plural laminates 114 as described later are wound around a transmitted gas collecting tube 112, an outermost periphery of the laminate 114 is covered with a covering layer 116, and telescope prevention plates 118 are attached on both ends of these units, respectively. If a raw material gas 120 containing an acid gas is fed to the laminate 114 from a side of one end portion 100A, the module 100 separates the raw material gas 120 into an acid gas 122 and a remaining gas 124 by the structure of the laminate 114 to discharge the gases separately to a side of the other end portion 100B.

The transmitted gas collecting tube 112 is a cylindrical tube in which a plurality of through-holes 112A are formed on a tube wall. A tube on a side of one end portion (one end portion 100A side) of the transmitted gas collecting tube 112 is closed, and a tube on a side of the other end portion (the other end portion 100B side) is opened to serve as a discharge port 126 through which the acid gas 122 such as carbon dioxide that is transmitted through the laminate and is collected from the through-holes 112A is discharged.

A shape of the through-holes 112A is not particularly limited, but 1 to 20 mm φ-circular holes are preferably opened. Moreover, the through-holes 112A are preferably uniformly arranged on a surface of the transmitted gas collecting tube 112.

The covering layer 116 is formed of a shutoff material that may shut off the raw material gas 120 that passes through an inside of the acid gas separation module 100. The shutoff material preferably further has heat and moisture resistance. Here, “heat resistance” of the heat and moisture resistance means that the material has heat resistance of 80° C. or higher. Specifically, the heat resistance of 80° C. or higher means that, even after the material is stored for 2 hours under temperature conditions of 80° C. or higher, a form before storage is maintained, and no visually confirmable curling due to thermal shrinkage or thermal fusion occurs. Moreover, “moisture resistance” of the heat and moisture resistance means that, even after the material is stored for 2 hours under conditions of 40° C. and 80% RH, the form before storage is maintained, and no visually confirmable curling due to thermal shrinkage or thermal fusion occurs.

The telescope prevention plate 118 is preferably formed of a heat and moisture-resistant material.

The laminate 114 is formed by laminating a member 135 for transmitted gas flow channel, a composite 110 for acid gas separation, a member 130 for fed gas flow channel and the composite 110 for acid gas separation, and a singular laminate or plural laminates are wound around the transmitted gas collecting tube 112. Owing to lamination of the membranes, the raw material gas 120 containing the acid gas 122 is fed from an end portion of the member 130 for fed gas flow channel. The acid gas 122 that is transmitted through the composite 110 for acid gas separation as divided by the covering layer 116 and is separated is accumulated into the transmitted gas collecting tube 112 through the member 135 for transmitted gas flow channel and the through-holes 112A, and is recovered from the discharge port 126 connected to the transmitted gas collecting tube 112. Moreover, the remaining gas 124 from which the acid gas 122 is separated, and which passes through pores of the member 130 for fed gas flow channel or the like, is discharged from an end portion of the gas separation composite 110 for acid gas separation.

The composite 110 for acid gas separation is produced according to the production method of the present disclosure, and is composed of the porous support obtained by laminating the hydrophobic porous membrane and the auxiliary support membrane, and the acid gas separation facilitated transport membrane disposed on the side of the porous membrane of the porous support and containing at least the hydrophilic polymer and the acid gas carrier that reacts with the acid gas in the raw material gas.

The number of sheets of laminates 114 to be wound around the transmitted gas collecting tube 112 is not particularly limited and may be singular or plural, but a membrane area of the facilitated transport membrane can be increased by increasing the number of sheets (number of lamination). Thus, an amount of the acid gas 122 separable by one module can be increased. In order to increase the membrane area, a length of the laminate 114 may also be further increased.

### (Member for Fed Gas Flow Channel)

The member 130 for fed gas flow channel is a member to which the material gas containing the acid gas is fed from one end portion of the acid gas separation module. The member 130 preferably has a function as a spacer, and causes turbulence for the raw material gas, and therefore a net-shaped member is preferably used. A gas flow channel changes depending on a shape of the net, and therefore the shape of a unit lattice of the net is selected from a shape such as a rhombus and a parallelogram according to the purpose, and used. Moreover, if feeding of a raw material gas containing the water vapor at a high temperature is assumed, the member for fed gas flow channel preferably has moisture and heat resistance in a manner similar to an acid gas separation layer described later.

A material of the member 130 for fed gas flow channel is not particularly limited. Specific examples include paper, high-quality paper, coated paper, cast-coated paper, synthetic paper, cellulose, a resin material such as polyester, polyolefin, polyamide, polyimide, polysulfone, aramid and polycarbonate, and an inorganic material such as metal, glass and ceramics. Specific examples of the resin material preferably include polyethylene, polystyrene, polyethylene terephthalate, polytetrafluoroethylene (PTFE), polyether sulfone (PES), polyphenylene sulfide (PPS), polysulfone (PSF), polypropylene (PP), polyimide, polyether imide, polyether ether ketone and polyvinylidene fluoride.

From a viewpoint of the moisture and heat resistance, specific examples of preferred material include an inorganic material such as ceramics, glass and metal, and an organic resin material having heat resistance of 100° C. or higher, and high molecular-weight polyester, polyolefin, heat-resistant polyamide, polyimide, polysulfone, aramid, polycarbonate, metal, glass, ceramics or the like can be preferably used. More specifically, the material is preferably composed by containing at least one material selected from the group consisting of ceramics, polytetrafluoroethylene, polyvinylidene fluoride, polyether sulfone, polyphenylene sulfide, polysulfone, polyimide, polypropylene, polyether imide and polyether ether ketones.

A thickness of the member for fed gas flow channel is not particularly limited, but is preferably 100 μm or more and 1,000 μm or less, further preferably 150 μm or more and 950 μm or less, and still further preferably 200 μm or more and 900 μm or less.

### (Member for Transmitted Gas Flow Channel)

The member 135 for transmitted gas flow channel is a member in which the acid gas that reacts with the carrier and is transmitted through the composite 110 for acid gas separation flows toward the through-holes. The member 135 for transmitted gas flow channel has the function as the spacer, and also has a function of allowing the transmitted acid gas to flow inwardly from the member 135 for transmitted gas flow channel. Specific examples include a tricot-knitted shape. As a material of the member for transmitted gas flow channel, a material similar to the material of the member for fed gas flow channel can be used. Moreover, if flowing of the raw material gas containing the water vapor at a high temperature is assumed, the member for transmitted gas flow channel preferably has the moisture and heat resistance similar to the acid gas separation layer.

As a specific raw material to be used in the member for transmitted gas flow channel, a polyester base such as epoxy-impregnated polyester, a polyolefin base such as polypropylene or a fluorine base such as polytetrafluoroethylene is preferred.

A thickness of the member for transmitted gas flow channel is not particularly limited, but is preferably 100 μm or more and 1,000 μm or less, further preferably 150 μm or more and 950 μm or less, and still further preferably 200 μm or more and 900 μm or less.

In the acid gas separation module, the composite for acid gas separation produced according to the production method of the present disclosure may be installed as a flat membrane, or can also be processed into a spiral type known as a reverse osmosis membrane module, or a pleated type having a shape described, for example in Japanese Unexamined Patent Publication No. 2010-279885, and used.

Further, the acid gas separation module as related to the present disclosure can be set in an acid gas separation device, and used.

### EXAMPLES

The present disclosure is described in more detail by way of Examples below.

### (Support)

A laminated membrane (supported PTFE) between a hydrophobic support of polytetrafluoroethylene (PTFE) being a hydrophobic porous membrane having a pore diameter of 0.05 μm, and a woven fabric of polytetrafluoroethylene as an auxiliary support membrane was arranged as a support.

### (Preparation Step)

A coating liquid for carbon dioxide separation was prepared by heating and stirring an aqueous solution adjusted to contain 6% cesium carbonate, a 2.5% PVA-PAA copolymer (Kuraray Co., Ltd; Kurastomer AP) and 0.025% glutaraldehyde (manufactured by Wako Pure Chemical Industries, Ltd.).

The application liquid for carbon dioxide separation was charged into a stainless-steel vessel (inner diameter: 4 cm, height: 12 cm) in which a viscometer cylinder (rotor) is adjusted to be sufficiently immersed into the application liquid. The stainless-steel vessel was immersed into a temperature-adjustable water bath, and a liquid temperature was adjusted to be 25° C. While the adjustment was continued, a B type viscometer (manufactured by Tech-Jam Co., Ltd., BL2 1 to 100,000 mPa·s/KN3312481) was operated to measure viscosity at 60 rpm was measured in accordance with JIS Z 8803. As a result, the viscosity of the above-described application liquid for carbon dioxide separation was 1.1 Pa·s (1,100cp).

### (Coating and Drying Step)

An initial layer formation step and a next layer formation step were sequentially performed by using a roll-to-roll applicator equipped with a coating unit and a drying unit. In addition, the next layer formation step was performed once herein.

As an application method, a blade coating method was selected, and a blade height was adjusted to perform application at a desired thickness of a liquid membrane. On the above occasion, a width of a porous support was adjusted to 500 mm and a width of coating was adjusted to 470 mm. An applicator having a drying oven with three zones of drying zone (8 m for each zone, a total: 24 m) was used, and a rate of application (feeding rate) was adjusted to 5 In/min. Temperatures in the drying zones were adjusted to 60° C./80° C./90° C. sequentially from a feeding side.

Thicknesses of liquid membranes to be coated were changed, and Examples 1 to 3 and Comparative Examples 1 to 4 as described below were performed.

### Example 1

As an initial layer formation step, a blade height was adjusted to coat a coating liquid at a liquid membrane thickness of 0.3 mm in a first layer (initial layer), and then the liquid membrane was dried in the above-mentioned drying oven to form on a support a carbon dioxide separation facilitation membrane as the initial layer. The support was wound, and then placed in a feeding unit again. As a next layer formation step, a blade height was adjusted to coat a coating liquid on a carbon dioxide separating layer to be 2.0 mm in the liquid membrane, and then the membrane was dried in a manner similar to the operation during forming the initial layer.

### Example 2

A blade height was adjusted to be 1.0 mm in the liquid membrane thickness in the first layer in Example 1, and to be 1.0 mm in a liquid membrane thickness in a second layer (next layer), respectively, and coating and drying were performed to obtain a composite for carbon dioxide separation.

### Example 3

A blade height was adjusted to be 1.0 mm in the liquid membrane thickness in the first layer in Example 1, and to be 3.0 mm in a liquid membrane thickness in a second layer (next layer), respectively, and coating and drying were performed to obtain a composite for carbon dioxide separation. In addition, temperatures in drying zones for the second layer were adjusted to 70° C./90° C./100° C. sequentially from a feeding side.

### Comparative Example 1

A blade height was adjusted to be 3.0 mm in the liquid membrane thickness in the first layer in Example 1, and coating and drying were performed to obtain a composite for carbon dioxide separation. No next layer was formed herein, and the coating and drying step was performed only once.

### Comparative Example 2

A blade height was adjusted to be 1.0 mm in the liquid membrane thickness in the first layer in Example 1, and to be 4.0 mm in a liquid membrane thickness in a second layer (next layer), respectively, and coating and drying were performed to obtain a composite for carbon dioxide separation.

### Comparative Example 3

A blade height was adjusted to be 2.0 mm in the liquid membrane thickness in the first layer in Example 1, and to be 1.0 mm in a liquid membrane thickness in a second layer (next layer), respectively, and coating and drying were performed to obtain a composite for carbon dioxide separation.

### Comparative Example 4

A blade height was adjusted to be 0.1 mm in the liquid membrane thickness in the first layer in Example 1, and to be 3.5 mm in a liquid membrane thickness in a second layer (next layer), respectively, and coating and drying were performed to obtain a composite for carbon dioxide separation.

### Evaluation Method

Surface states of facilitated transport membranes after coating and drying of a first layer and a second layer, and process adaptability during coating of the first layer and the second layer were examined to evaluate each Example. As the process adaptability, existence or nonexistence of dirt such as adhesion of membrane onto a surface in contact with a conveying roll (touch roll) on which a coated surface is brought into contact was examined. All of the surface states of the facilitated transport membranes and the state of dirt on the surface in contact with the roll were visually observed.

The results are shown in Table 1.

TABLE 1

| | EXAMPLE | EXAMPLE | EXAMPLE | COMPARATIVE | COMPARATIVE | COMPARATIVE | COMPARATIVE |
|---|---|---|---|---|---|---|---|
| | 1 | 2 | 3 | EXAMPLE 1 | EXAMPLE 2 | EXAMPLE 3 | EXAMPLE 4 |
| THICKNESS OF | 0.3 mm | 1.0 mm | 1.0 mm | 4.0 mm | 1.0 mm | 2.0 mm | 0.1 mm |
| LIQUID MEMBRANE | | | | | | | |
| IN FIRST LAYER | | | | | | | |
| THICKNESS OF | 1.0 mm | 1.0 mm | 3.0 mm | — | 4.0 mm | 1.0 mm | 3.5 mm |
| LIQUID MEMBRANE | | | | | | | |
| IN SECOND LAYER | | | | | | | |
| SURFACE STATE OF | GOOD | GOOD | GOOD | STRONG | GOOD | STRONG | GOOD |
| SEPARATING LAYER | | | | UNEVENNESS | | UNEVENNESS | |
| AFTER COATING AND | | | | AND UNDRIED | | | |
| DRYING OF FIRST | | | | PORTION | | | |
| LAYER | | | | | | | |
| SURFACE STATE OF | GOOD | GOOD | GOOD | — | UNEVENNESS IN | STRONG | UNEVENNESS IN |
| SEPARATING LAYER | | | | | DRYING AND | UNEVENNESS | DRYING AND |
| AFTER COATING AND | | | | | IRREGULARITY | | IRREGURARITY |
| DRYING OF SECOND | | | | | | | |
| LAYER | | | | | | | |
| PROCESS | GOOD | GOOD | GOOD | DIRT ON ROLL | GOOD | GOOD | GOOD |
| ADAPTABILITY | | | | | | | |
| DURING COATING | | | | | | | |
| FIRST LAYER | | | | | | | |
| PROCESS | GOOD | GOOD | SLIGHTLY | — | FREQUENT DIRT | GOOD | FREQUENT DIRT |
| ADAPTABILITY | | | CLOUDED | | ON ROLL | | ON ROLL |
| DURING COATING | | | ON ROLL | | BEFORE | | BEFORE |
| SECOND LAYER | | | BEFORE | | WINDING | | WINDING |
| | | | WINDING | | | | |
| JUDGEMENT | A | A | B | C | C | C | C |

In Examples 1 and 2, evaluations in all were satisfactory, which was good (A) as the production method. In Example 3, slight dirt was found on the roll during coating the liquid on the second layer, but the composite that was sufficiently usable was obtained, and therefore judgement was made to be acceptable (B). On the other hand, in Comparative Examples 1, 2 and 4, unevenness in drying, undried portions, irregularity and so forth were found on the surface of the membrane after the coating liquid was coated and dried on the first layer or the second layer, and also the dirt on the roll was found. Therefore, judgment was made to be unacceptable (C). In Comparative example 3, no adhesion on the roll was found in both the first layer and the second layer, but a high level of unevenness was found in the surface state, and judgment was made to be unacceptable (C).

What is claimed is:

1. A method of producing a composite for acid gas separation, the composite provided with an acid gas separation facilitated transport membrane having a function of separating an acid gas in a raw material gas on a porous support, comprising:
a coating liquid preparation step for preparing a coating liquid for formation of the acid gas facilitated transport membrane, the coating liquid containing a hydrophilic compound, an acid gas carrier and water;
an initial layer formation step for forming a first acid gas separation facilitated transport membrane by using as the porous support a laminated membrane between a hydrophobic porous membrane and an auxiliary support membrane, coating on a surface of the hydrophobic porous membrane of the laminated membrane the coating liquid for formation at a liquid membrane thickness of 0.3 mm or more and 1.0 mm or less, and drying the coated liquid membrane; and
a next layer formation step one or more times for forming a next acid gas separation facilitated transport membrane by further coating on the previously formed acid gas separation facilitated transport membrane the coating liquid for formation of the acid gas separation facilitated transport membrane, and drying the coated liquid membrane.

2. The method of producing the composite for acid gas separation according to claim 1, wherein the coating liquid for formation of the acid gas separation facilitated transport membrane has a measured value of viscosity, at a temperature of 15° C. or higher and 35° C. or lower and at 60 rpm in the number of revolutions in B type viscosity measurement, is 0.5 Pa·s or more and 5 Pa·s or lower.

3. The method of producing the composite for acid gas separation according to claim 1, wherein, in the next layer formation step, the coating liquid for formation of the acid gas separation facilitated transport membrane is coated at a liquid membrane thickness of 3.0 mm or less.

4. The method of producing the composite for acid gas separation according to claim 1, wherein a coating method is a roll coating method or a blade coating method. The method of producing the composite for acid gas separation according to claim 1, wherein the hydrophilic compound is a polyvinyl alcohol-polyacrylic acid copolymer.

5. The method of producing the composite for acid gas separation according to claim 1, wherein the hydrophilic compound is a polyvinyl alcohol-polyacrylic acid copolymer.

6. The method of producing the composite for acid gas separation according to claim 1, wherein the acid gas carrier contains a compound containing at least one selected from alkali metal carbonate.

7. The method of producing the composite for acid gas separation according to claim 1, wherein, in the coating liquid preparation step, as the coating liquid for formation of the acid gas separation facilitated transport membrane, a plurality of coating liquids for formation in which concentrations of the acid gas carrier are different are prepared, and
in the next layer formation step, a next layer acid gas separation facilitated transport membrane is formed by using a coating liquid for formation in which a concentration of the acid gas carriers is different from the concentration of the coating liquid for formation upon forming the previously formed acid gas separation facilitated transport membrane.
